(19) United States
(12) Patent Application Publication
(10) Pub. No.: US 2004/0226762 A1
(43) Pub. Date: Nov. 18, 2004

(54) Fork-lift reach truck

(76) Inventor: Sebastian Huther, Kaltenkirchen (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/828,655

(22) Filed: Apr. 21, 2004

(30) Foreign Application Priority Data
May 14, 2003 (DE) 103 21 569.7

(51) Int. Cl. B60K 1/00

(52) U.S. Cl. 180/65.1

(57) ABSTRACT

A fork-lift reach truck having a driving portion and a mast portion wherein the driving portion has at least one steerable rear driving wheel driven by a drive motor, and a steering motor to steeringly operate the driving wheel, and two load-carrying front wheels which are rotatably supported in parallel-spaced wheel arms, electromagnetic braking devices for the load-carrying wheels, and a control device for controlling the drive motor, the steering motor, and the braking devices in dependence on the actuation of control elements in the fork-lift reach truck, wherein each load-carrying wheel or a ring-shaped disc mounted on the load-carrying wheel, laterally in a circumferential direction and at a uniform spacing, has teeth, elevations and/or slots or the like, and that the wheel arm has fixed thereto a proximity sensor which, upon rotation of the load-carrying wheel, in a speed-dependent way generates sensor pulses which are inputted to said control device.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The peculiar feature of fork-lift reach trucks is that the mast or lift frame is movable with respect to the driving portion. In most cases, the driving portion centrally has a driving wheel at the rear that also is a steered wheel. A drive motor and a steering motor are provided to actuate the driving wheel. The front end of the driving portion has disposed thereon parallel-spaced wheel arms which support load-carrying wheels. Furthermore, support rails for the mast holder are integrated in the wheel arms so that the mast holder, along with the mast, can be moved between the wheel arms.

It is known to associate brakes with both the driving wheel and load-carrying wheels. The brake for the driving wheel can be associated directly with the drive motor. DE 196 29 386 C1 has made it known to achieve a braking effect via the drive motor as a generator.

It is known to provide the brake of the load-carrying wheels with hydraulic or electric braking devices. EP 0758591 A1 has made it known to generate an electric braking signal by means of a brake signal generator which is actuated by a brake pedal. In most cases, the electric brake is configured in such a way that a ring-shaped brake magnet is firmly attached to the wheel arm and extends into the interior of the cup-shaped supporting wheel. The brake magnet interacts with a brake disc which, while being axially movable to a limited extent, is disposed in the interior of the load-carrying wheel and rotates along with the load-carrying wheel.

It is the object of the invention to configure a fork-lift reach truck so as to enable a determination of the number of revolutions of the load-carrying wheels.

### BRIEF SUMMARY OF THE INVENTION

In the inventive fork-lift reach truck, each load-carrying wheel or a ring-shaped disc mounted on said load-carrying wheel, laterally in a circumferential direction and at a uniform spacing, is provided with teeth, elevations and/or slots or the like. The wheel arm has fixed thereto a proximity sensor which, upon rotation of said load-carrying wheel, in a speed-independent way generates sensor pulses which are inputted to said control device.

The sensor disc which preferably is directed towards the vehicle's inner contour because there is a necessary construction space for a disc and a sensor can be screwed, pasted or riveted to or even pressed into the load-carrying wheel. Alternatively, it is possible to provide the load-carrying wheel itself with a front-end face series of teeth or similar indentations which are manufactured using appropriate tooth-forming methods. As is mentioned the sensor is a proximity sensor which operates by induction or is formed by a Hall sensor, for example, and is adequately insensitive to impurities and harsh operating conditions.

Such a speed sensor can help in determining the number of revolutions on each load-carrying wheel, which is an advantage, in particular, when the industrial truck is rotated about the load-carrying axle, one or more wheels are blocked, and the load-carrying wheels run at a relative speed, e.g. in cornering. Therefore, it is possible to brake the load-carrying wheels individually from the control device in dependence on their speed in order to prevent unstable travel conditions or an load-carrying wheel from undesirably getting blocked while it is braked. It is understood that a purposeful braking of the individual load-carrying wheels can also be made to depend upon more parameters, e.g. a cornering travel or the cornering radius.

According to another aspect of the invention, the ring-shaped disc is mounted on the cup-shaped load-carrying wheel in such a way that it conceals the radial gap between the brake magnet and the load-carrying wheel. This is an advantage in that few impurities can get into the brake and, in addition, the brake will not fall out of the load-carrying wheel during assembly. If the speech is about brake magnets it means a brake unit which incorporates an electromagnet, but specifically also includes a casing surrounding the magnet which is fixed to the wheel arm.

As was mentioned already a fork-lift reach truck, on the wheel arms, has support rails for the mast holder. According to an aspect of the invention, the proximity sensor is fixed to the underside of the support rails near the free end of said wheel arm. Accordingly, the guide of the cable for the proximity sensor is provided at the underside of the support rails. For this purpose, a tube or appropriate protective profile may be mounted on the underside to prevent the sensor cable from becoming damaged or destroyed when in operation.

According to another aspect of the invention, it is advantageous for the brake magnet, on the side facing the driving portion, to have mounted thereon a protective component for a sensor cable between the brake magnet and the support rail wherein the sensor cable is guided in the wheel arm up to said protective component and, after said protective component is guided at the underside of the support rails and is mounted there. The protective component can also guides the brake cable which is also led up via the wheel arm profile. According to an aspect of the invention, the protective component is integrally formed from a cut-to-size metal sheet with two superposed, spaced jaws which are fixed to said brake magnet and bear against the support rail. This provides both a horizontal guide channel and vertical guide channel to receive the brake cable and the sensor cable. It is understood that the protective component can also be molded from a plastic.

The invention will be described in more detail below with reference to an embodiment illustrated in the drawings.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

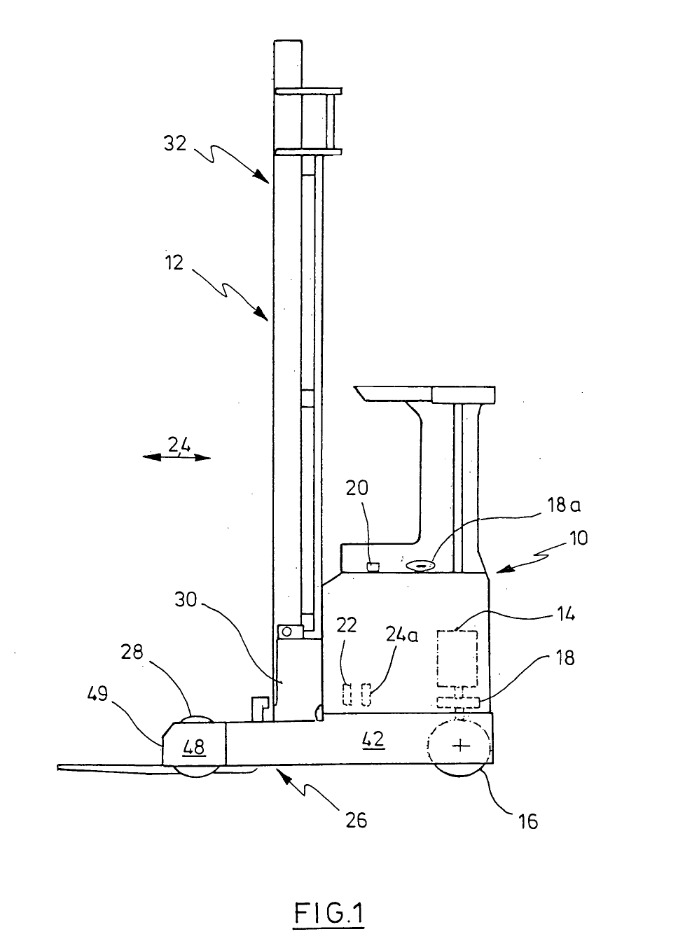

FIG. 1 schematically shows a side view of a fork-lift reach truck according to the invention.

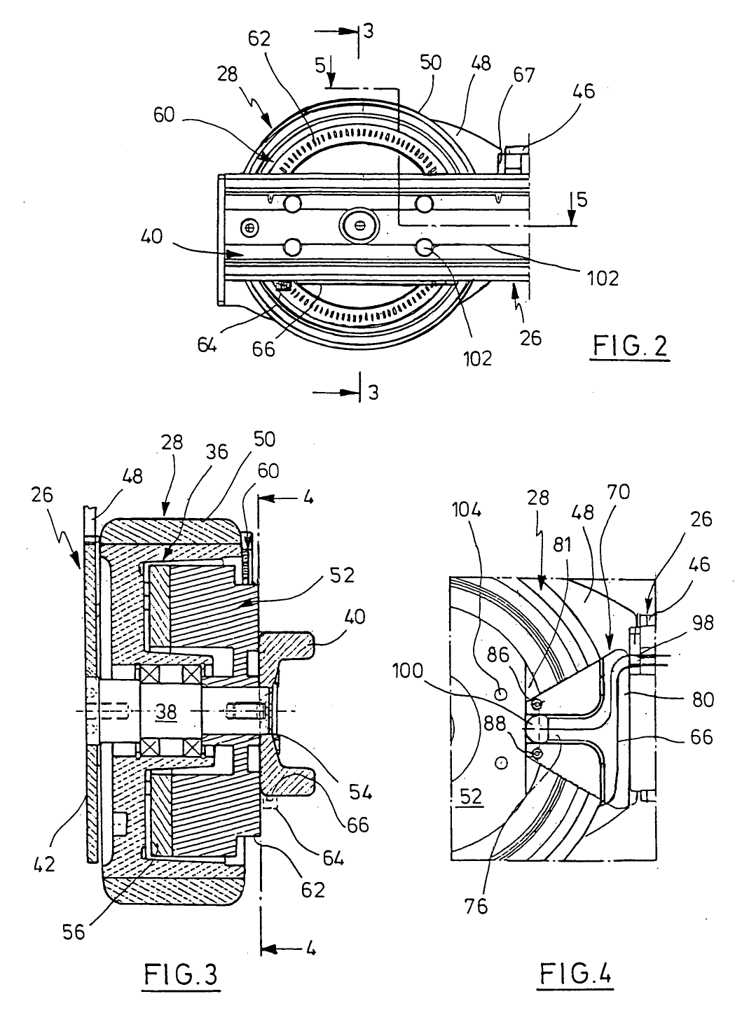

FIG. 2 shows the end of a wheel arm of the fork-lift reach truck of FIG. 1 from the inside.

FIG. 3 shows a section through the representation of FIG. 2 along lines 3-3.

FIG. 4 shows a section through the representation of FIG. 3 along lines 4-4.

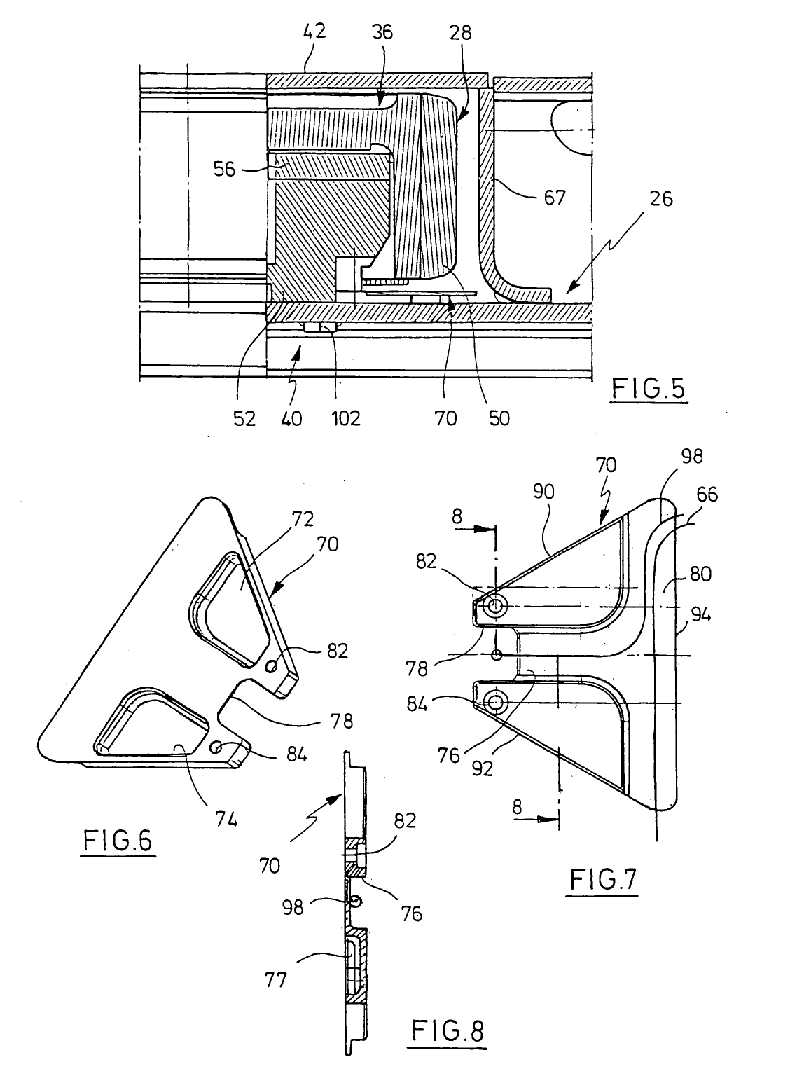

FIG. 5 shows a section through the representation of FIG. 2 along lines 5-5.

FIG. 6 shows an isometric representation of a protective component in the area of the load-carrying wheel of FIGS. 2 through 5.

FIG. 7 shows a side view of the protective component of FIG. 6 from the underside.

FIG. 8 shows a section through the representation of the protective component of FIG. 7 along lines 8-8.

FIG. 1 schematically shows a side view of a fork-lift reach truck with a driving portion 10 and a load-carrying portion 12. In a casing, the driving portion, contains a drive motor 14 (shown in phantom lines) which drives a rear driving wheel 16. Furthermore, the driving wheel 16 can be pivoted about a vertical axis via an appropriate bearing 18 and by means of a steering motor (not shown). The driving portion also has provided therein a driver's seat (not shown in detail) from which a steering wheel 18a and a control element 20 can be actuated. The driver's seat also includes an accelerator 22 and a brake pedal 24a (also shown in phantom lines). Wheel arms one of which can be recognized at 26 extend on either side of the driving portion 10. At the front end, the wheel arms support load-carrying wheels, of which the load-carrying wheel 26 is illustrated. A mast holder 30 holds a lifting mast 32 with the mast holder 30 being displaceable along support rails, which are mounted each at the inside of the wheel arms 26, in the direction of the two-sided arrow 34. The particulars described are generally known for fork-lift reach trucks. Merely the support of the load-carrying wheel 28 and the braking device for the load-carrying wheel will be discussed below. As is understood the structure for the other wheel arm is identical.

The structure of the load-carrying wheel is evident from FIGS. 2 through 5. The load-carrying wheel 28 has a cup-shaped wheel body 36 which is rotatably supported by means of an axle pivot pin 38 and two antifriction bearings. The wheel arm 26 has a in the form of an upright U profile. In parallel with and at a distance from the support rail 40, the wheel arm 26 further has a wheel arm profile with an elongate vertical sheet metal part 42 which extends in parallel with and at a distance from the support rail 40. The axle pivot pin 38 is mounted in openings of the support rail 40 and sheet metal part 42. The wheel arm profile has an upper cover for the wheel arm that is formed by a turned-over element of the sheet metal panel 42. The upper cover is outlined at 46 in FIGS. 2 and 4. The sheet metal panel 42 widens at the outside of the load-carrying wheel 28 as can be recognized at 48 in FIGS. 2 through 4. The load-carrying wheel 28 projects beyond the wheel arm 26 both at top and bottom.

The wheel body 36 has tires 50 reference to which will not be made here. As was mentioned, the body is of a cup shape to receive an electromagnetic braking device. The device comprises a ring-shaped brake magnet 52. (If the speech is about a brake magnet hereinafter it primarily means the overall assembly including the casing. Reference will not to be made to the magnet in detail). The brake magnet 52 is supported about the axle pivot pin 38 by a cylindrical portion 54. A brake disc 56 is axially movable to a limited extent between the wheel body 36 and the stationary brake magnet 52, but is rotationally fixed to the wheel body 36. When the brake magnet 52 is actuated the brake disc 56 is pulled against the brake magnet 52 and braking by friction takes place. Reference to the structure of the braking surfaces need not be made in detail because it is known as such.

A sensor ring 60 is fixed to the inside of the rim of the wheel body 36. It may be fixed by screwing, riveting or pasting or by pressing it into an appropriate recess of the rim. The sensor ring 60 extends radially inwards into a ring-shaped recess 62 of the brake magnet 52 and largely overlaps the gap between the brake magnet 52 and the brake disc 56, on one hand, and the wheel body 36, on the other. This manner makes it more difficult for impurities to enter the brake.

As is evident from FIG. 2 the sensor ring 60 is provided with a circular array of radial slots 62 which are disposed at uniform distances. In lieu of the slots 62, provision can be made for elevations or other raised areas in order to be detected by a proximity sensor 64. The proximity sensor 64 is arranged at the underside of the support rail 40. It operates by induction or as a Hall sensor, for example.

The proximity sensor 64 generates pulses in dependence on the speed of the load-carrying wheel 28, which are led, via a sensor cable, to a control device (not shown) in the driving portion 10 of the fork-lift reach truck. Such a cable is arranged at 66 in FIG. 4. It is led up via the wheel arm 26 and enters the space which receives the load-carrying wheel 28 and the braking device in the wheel arm 26. The arm is separated by a transverse partition 67 from the remaining wheel arm as is apparent from FIG. 5. This region has seated therein a protective component 70 which is mounted on the brake magnet 52 and is arranged between the load-carrying wheel 28 and the brake magnet 52, on one hand, and the rail 40, on the other. The structure of the protective component 70 ensues more distinctly from FIGS. 6 through 8.

The protective component 70 is trapezoidal in contour and is integrally formed from a cut-to-size metal sheet. On either side of the longitudinal axis, trapezoidal indentations 72, 74 are embossed which, as elevations on the opposite side, define a horizontal guide channel 76 which opens into a recess 78 at the tapered end of the protective component 70. On the opposite side, a vertical guide channel 80 is formed which extends over the length of the protective component 70 at the other end. At the tapered end, the protective component 70 has openings 82, 84 on the opposed sides of the recess 78. These openings 82, 84 can help in bolting the protective component 70 in a recess 81 of the brake magnet 52 as is outlined at 86 and 88 in FIG. 4. The protective component 70 is provided with a turned-over element 90 and 92 in the area of the embossed indentations 72, 74 at the outside (also see FIG. 6). At the wider end, the guide channel 80 is substantially defined by rear sides of the embossed indentations 72, 74 or elevations and a flat portion 94 of the protective component 70.

As was mentioned, the sensor cable 66 is guided to be protected in the wheel arm 26 and exits from the wheel arm and into the reception space for the load-carrying wheel 28 while being downwardly deflected through 90° into the guide channel 80. The guide channel 80 is outwardly restricted by the support rail 40. Subsequently, the sensor cable 66 is then passed down beneath the support rail 40 as is shown in phantom lines at 66 in FIG. 3. Since it needs to be fastened to the support rail 40 it is preferred to mount a protective tube or protective profiled member at the underside of the support rail 40, which is not shown, however.

As is further evident from FIGS. 4, 7, and 8 a so-called brake cable 98 is also guided in the wheel arm 26 and is downwardly deflected like the sensor cable in the guide channel 80. However, it is deflected back to the former direction again into the channel 76 and, thence, into a port 100 of the brake magnet 56 as is outlined in FIG. 4. The channel is oriented to the port 100 and the port 100 is located in the area of the recess 78 of the component 70. Therefore, the cables 66, 98 are sufficiently protected from damage and other adverse effects in the area of the load-carrying wheel 28.

For the assembly of the load-carrying wheel and brake, the brake disc 56 and the brake magnet 52 are first mounted on the carrier wheel 36. At this stage, the sensor disc 60 initially is loosely arranged in the recess 62. After the brake is assembled the sensor ring is appropriately fixed to the wheel body 36, e.g. by using screws. Thereafter, the protective component 70 is attached to the brake magnet 52. The brake cable 98 has been connected to the port and the sensor cable 66 has been placed in the protective component 70. Subsequently, the entire assembly is inserted into the wheel arm 26 and is fixed in place by introducing the axle pivot pin 38. The pin 38 is mounted in the support rail 40 and the lateral metal sheet 42 in a way which is not described. Then, the brake magnet 52 is bolted to the support rail 40 as is shown at 102 in FIG. 2. For this purpose, a total of four threaded bolts 102 are used which are screwed into threaded bores of the brake magnet 52. Two threaded bores can be seen at 104 in FIG. 2.

The protective component 70 can be of an identical shape for the two wheel arms.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A fork-lift reach truck having a driving portion and a mast portion wherein said driving portion has at least one steerable rear driving wheel driven by a drive motor, and a steering motor to steeringly operate said driving wheel, and two load-carrying front wheels which are rotatably supported in parallel-spaced wheel arms, electromagnetic braking devices for said load-carrying wheels, and a control device for controlling said drive motor, said steering motor, and said braking devices in dependence on the actuation of control elements in said fork-lift reach truck, characterized in that each load-carrying wheel (28) or a ring-shaped disc (60) mounted on said load-carrying wheel (28), laterally in a circumferential direction and at a uniform spacing, has teeth, elevations and/or slots or the like, and that said wheel arm (26) has fixed thereto a proximity sensor (64) which, upon rotation of said load-carrying wheel (28), in a speed-dependent way generates sensor pulses which are inputted to said control device.

2. The fork-lift reach truck according to claim 1, characterized in that said ring-shaped disc (60) is mounted on the inside of said load-carrying wheel (28).

3. The fork-lift reach truck according to claim 1, characterized in that said ring-shaped disc (60) is screwed, pasted or riveted to or pressed into said load-carrying wheel (28).

4. The fork-lift reach truck according to claim 1, characterized in that a ring-shaped brake magnet (52) is firmly attached to the inside of said wheel arm (26) and extends into the interior of said cup-shaped load-carrying wheel (28) and interacts with an axially movable brake disc (56) rotating along with said load-carrying wheel (28), and that the sensor disc (60) is mounted on the open side of said load-carrying wheel (28) and radially faces inwards and overlaps the radial gap between said brake magnet (52) and said load-carrying wheel (28).

5. The fork-lift reach truck according to claim 1, characterized in that said wheel arms (26) have a longitudinal profile formed from a turned-over metal sheet and a support rail (40) at the inside of said longitudinal profile, an axle pivot pin (38) supporting said load-carrying wheel (28) is supported in said support rail (40) and a parallel-spaced metal sheet (42) of said longitudinal profile, and the proximity sensor (64) is fixed to the underside of said support rail (40) near the free end of said wheel arm (26).

6. The fork-lift reach truck according to claim 5, characterized in that the side facing said driving portion (10), on said brake magnet (52), has mounted thereon a protective component (70) for a sensor cable (66) between said brake magnet (52) and said support rail (40) wherein said sensor cable (66) is guided in the wheel arm (26) up to said protective component (70) and, after said protective component (70), is guided to said underside of said support rail (40) and is mounted there.

7. The fork-lift reach truck according to claim 5, characterized in that said protective component (70) also guides a brake cable (98) for said brake magnet (52) that is led up inside said wheel arm (26).

8. The fork-lift reach truck according to claim 6, characterized in that said protective component (70) is integrally formed from a cut-to-size metal sheet with two superposed, spaced jaws (72, 74) which are fixed to said brake magnet (52) and bear against said support rail (40) so as to define a horizontal guide channel (76) for said brake cable (98) and a vertical guide channel (80) located transverse thereto for said brake cable (98) and said sensor cable (66).
